(19) United States
(12) Patent Application Publication
(10) Pub. No.: US 2016/0352733 A1
(43) Pub. Date: Dec. 1, 2016

(54) DISTRIBUTED AND HIERARCHICAL DEVICE ACTIVATION MECHANISMS

(71) Applicant: Rubicon Labs, Inc., San Francisco, CA (US)

(72) Inventors: William V. Oxford, Austin, TX (US); Roderick Schultz, San Francisco, CA (US); Gerald E. Woodcock, III, Austin, TX (US); Stephen E. Smith, Austin, TX (US); Alexander Usach, San Francisco, CA (US); Marcos Portnoi, Austin, TX (US)

(21) Appl. No.: 15/167,254

(22) Filed: May 27, 2016

Related U.S. Application Data
(60) Provisional application No. 62/166,907, filed on May 27, 2015.

(51) Int. Cl. H04L 29/06; H04L 9/30; H04L 9/14; H04L 9/32

(52) U.S. Cl. CPC H04L 63/0876; H04L 9/3242; H04L 9/30; H04L 9/14; H04L 63/06

(57) ABSTRACT

Embodiments of systems and methods disclosed herein include a distributed device activation mechanism involving a group of external entities without using asymmetric cryptography. Systems and methods include techniques for deriving a device secret using a hardware secret and authenticated unique input data provided to the device by one or more external entities. A hardware hash function uses the hardware secret as a key and the authenticated unique input data as input data to output the derived device secret. The derived device secret is written to a security register of the device to enter a new security layer.

### RELATED APPLICATIONS

This application claims a benefit of priority under 35 U.S.C. §119 to U.S. Provisional Patent Application No. 62/166,907 filed May 27, 2015, entitled “DISTRIBUTED AND HIERARCHICAL DEVICE ACTIVATION MECHANISMS”, by William V. Oxford et al., which is hereby fully incorporated by reference in its entirety.

### TECHNICAL FIELD

This disclosure relates in general to security in computer systems. More specifically, this disclosure relates generally to establishing a secure boundary within a specific device that is associated with group of one or more external service providers. In particular, certain embodiments relate to an efficient and secure authorization system using a distributed device activation procedure. Other embodiments relate to an efficient and secure authentication system using a hierarchical activation mechanism.

### BACKGROUND

There is a need for a simple and effective method to perform remote authentication and activation in a secure manner for a connected device after it has been deployed in the field. For example, when the processor of a device is executing secure code, the processor stores intermediate data (i.e., a working set) while processing the secure task. A problem arises when it is desired to pass the secure data to another secure execution task running on the same processor. It is difficult to encrypt the data in such a way that the original owner of the data, once encrypted, can't decrypt it, and the new owner is able to decrypt it, while not knowing how it was encrypted.

In the case where a device contains a single fixed secret, then that remote authentication and activation may be a relatively straightforward procedure. However, such a device may consist of an assembly of individual components, all of which may be required to share their individual secrets with different remote entities. Such an exemplary assembly may include one or more semiconductor devices assembled on a motherboard or module by a systems integrator. The assembled device may ultimately be activated by a service provider and used by an end customer (user) to run one or more applications developed by a software vendor. For the device to function in a secure manner, the various components and systems (e.g., semiconductor manufacturer, systems integrator, service provider, software vendor, user, etc.) used in a given task must cooperate and the group must collectively establish a shared secret, even though the underlying entities may not necessarily share trust (i.e., they do not wish to share their individual secrets with each another).

Accordingly, there is a need to find systems and methods by which the data of such security systems may likewise be secured, where by securing such data the effectiveness of such a security system may be enhanced.

### SUMMARY OF THE DISCLOSURE

In a first example, a hierarchical activation mechanism may be used. Such a hierarchical activation mechanism can be thought of in terms of “layers”, where each layer may represent a security boundary, within which information must be shared. When such a device attempts to execute a secure operation, a new layer may be formed -based, in whole or in part, on secrets that are known to the current security layer. In this case, the hierarchical activation mechanism may generate a new secret that will be used in the newly-created layer, but will not be available to other layers.

This device secret is subsequently used for authenticating the device and enabling secure communications between the individual components of a newly-created layer (based on this new device secret). Note that the newly-created layer is specifically not the same layer in which the new device secret is first created. Effectively, in this scheme, any given security layer (and its boundaries) for a device can be most simply described as each being bound to a unique device secret. Thus, a given security layer cannot, by definition, create its own secret.

In another example, a distributed device activation mechanism may be used. In this example, a device secret is derived from a hardware secret using the hardware secret and unique input data. Some part of the unique input data may or may not be provided to the device by one or more external entities. If one or more pieces of this unique input data is provided by external entities, however, each piece should also be combined with some means of authenticating the external entity with the device. Also, some form of device-specific private (i.e., not shared with any external entities) entropy may be combined with the externally-provided input data pieces prior to generating the device secret. As mentioned above, once a newly-created secret is written to the device's “security layer base register” (also referred as the device's Zero Knowledge Secret register), then the device necessarily must enter a new security layer; one where the device then may not have access to any of the data that was created within a different security boundary (one that was not based on this newly-created device secret). Thus, in this case, we have created a new (virtual) secure device; one that is defined by known values (e.g., the device's serial number and the input values that are used to evaluate secure functions and the resulting output) and at least one unknown value (the value stored in the device's Zero Knowledge Secret register).

However, in a distributed device activation scheme (and prior to the device entering into the new security layer), the newly-created device secret can then be split into separate independent pieces (while the device is still executing in the “parent” security layer). Each of the pieces of the newly-created secret may then be communicated with an external entity in a secure manner. These external entities may or may not be the same entities that may have participated in the creation of the new device secret in the first place. In this manner, one or more of these external entities may then be required to participate in the authentication and/or authorization process for the device once it enters the newly-created security layer. Note that, due to the virtual nature of the Zero-Knowledge Secret-based device definition, then one or more of these “external” entities may, in fact, be the exact same device, but operating and communicating from within a separate (different) security layer. Thus, a single device may be used in this manner to realize the same logical effect as a truly distributed device activation scheme, but without requiring that the device ever establish secure communications with any external entities. The exact mechanism that is employed to enforce the participation requirements and the derivation of the various separate pieces of the newly-created secret is flexible, as is the set of rules that define the operation of this secret-splitting process.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 depicts one embodiment of an architecture for content distribution.

FIG. 2 depicts one embodiment of a target device loading a secure candidate code block.

FIG. 3 depicts one embodiment of a target device.

FIG. 4 depicts a block diagram illustrating system-wide relationship examples of a system that may be used with the present disclosure.

FIG. 5 illustrates a first example of a hierarchical activation mechanism.

FIG. 6 is a functional block diagram of an example of a hierarchical device management system.

FIG. 7 is a diagram illustrating an example of a device hierarchical activation authorization sequence.

FIG. 8 is a diagram illustrating an example of a device secret update sequence.

FIG. 9 is a block diagram illustrating an example of distributed device activation.

FIGS. 10-13 are block diagrams illustrating examples of distributed device activation mechanisms.

FIGS. 14-16 are block diagrams illustrating examples of distributed device activation mechanisms.

### DETAILED DESCRIPTION

The disclosure and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

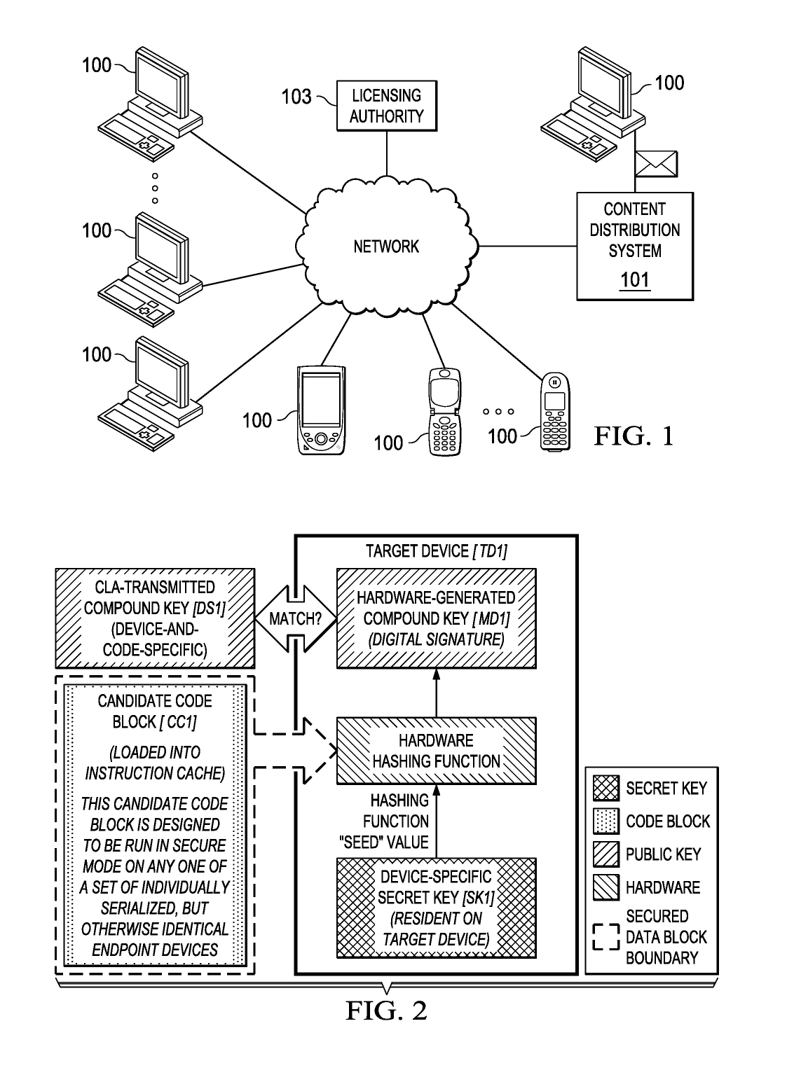

Before discussing embodiments in detail, it may helpful to give a general overview of an architecture in which embodiments of the present invention may be effectively utilized. FIG. 1 depicts one embodiment of such a topology. Here, a content distribution system 101 may operate to distribute digital content (which may be for example, a bitstream comprising audio or video data, a software application, etc.) to one or more target units 100 (also referred to herein as target or endpoint devices) which comprise protocol engines. These target units may be part of, for example, computing devices on a wireline or wireless network or a computer device which is not networked, such computing devices including, for example, a personal computers, cellular phones, personal data assistants, media players which may play content delivered as a bitstream over a network or on a computer readable storage media that may be delivered, for example, through the mail, etc. This digital content may compose or be distributed in such a manner such that control over the execution of the digital content may be controlled and security implemented with respect to the digital content.

In certain embodiments, control over the digital content may be exercised in conjunction with a licensing authority 103. This licensing authority 103 (which may be referred to as a central licensing authority, though it will be understood that such a licensing authority need not be centralized and whose function may be distributed, or whose function may be accomplished by content distribution system 101, manual distribution of data on a hardware device such as a memory stick, etc.) may provide a key or authorization code. This key may be a compound key (DSn), that is both cryptographically dependent on the digital content distributed to the target device and bound to each target device (TDn). In one example, shown in FIG. 2, a target device TD1 may be attempting to execute an application in secure mode. This secure application or code (which may be referred to as candidate code or a (secure) candidate code block (e.g., CC1)) may be used in order to access certain digital content.

Accordingly, to enable a candidate code block to run in secure mode on the processor of a particular target device 100 to which the candidate code block is distributed, the licensing authority 103 must supply a correct value of a compound key (one example of which may be referred to as an Authorization Code DS1) to the target device on which the candidate code block is attempting to execute in secure mode (e.g., supply DS1 to TD1). No other target device (e.g., TDn, where TDn≠TD1) can run the candidate code block correctly with the compound key (e.g., DS1) and no other compound key (DSn assuming DSn≠DS1) will work correctly with that candidate code block on that target device 100 (e.g., TD1).

As will be described in more detail later on herein, when Target Device 100 (e.g., TD1) loads the candidate code block (e.g., CC1) into its instruction cache (and, for example, if CC1 is identified as code that is intended to be run in secure mode), the target device 100 (e.g., TD1) engages a hash function (which may be hardware based) that creates a message digest (e.g., MD1) of that candidate code block (e.g., CC1). The seed value for this hash function is the secret key for the target device 100 (e.g., TD1's secret key (e.g., SK1)).

In fact, such a message digest (e.g., MD1) may be a Message Authentication Code (MAC) as well as a compound key, since the hash function result depends on the seed value of the hash, the secret key of the target device 100 (e.g., SK1). Thus, the resulting value of the message digest (e.g., MD1) is cryptographically bound to both the secret key of the target device 100 and to the candidate code block. If the licensing authority distributed compound key (e.g., DS1) matches the value of the message digest (e.g., MD1) it can be assured that the candidate code block (e.g., CC1) is both unaltered as well as authorized to run in secure mode on the target device 100 (e.g., TD1). The target device 100 can then run the candidate code block in secure mode.

As can be seen then, in one embodiment, when secure mode execution for a target device 100 is performed the target device 100 may be executing code that has both been verified as unaltered from its original form, and is cryptographically “bound” to the target device 100 on which it is executing. This method of ensuring secure mode execution of a target device may be contrasted with other systems, where a processor enters secure mode upon hardware reset and then may execute in a hypervisor mode or the like in order to establish a root-of-trust.

Accordingly, using embodiments as disclosed, any or all of these data such as the compound key from the licensing authority, the message digest, the candidate code block, etc. (e.g., DS1, MD1, CC1) may be completely public as longs as the secret key for the target device 100 (e.g., SK1) is not exposed. Thus, it is desired that the value of the secret key of a target device is never exposed, either directly or indirectly. Accordingly, as discussed above, embodiments of the systems and methods presented herein, may, in addition to protecting the secret key from direct exposure, protect against indirect exposure of the secret key on target devices 100 by securing the working sets of processes executing in secure mode on target devices 100.

Embodiments as presented herein may be better understood with reference to U.S. Pat. No. 7,203,844, issued Apr. 10, 2007, entitled “Recursive Security Protocol System and Method for Digital Copyright Control”, U.S. Pat. No. 7,457,968, issued Nov. 25, 2008, entitled “Method and System for a Recursive Security Protocol for Digital Copyright Control”, U.S. Pat. No. 7,747,876, issued Jun. 29, 2010, entitled “Method and System for a Recursive Security Protocol for Digital Copyright Control”, U.S. Pat. No. 8,438,392, issued May 7, 2013, entitled “Method and System for Control of Code execution on a General Purpose Computing Device and Control of Code Execution in an Recursive Security Protocol”, U.S. Pat. No. 8,726,035, issued May 13, 2014, entitled “Method and System for a Recursive Security Protocol for Digital Copyright Control”, U.S. patent application Ser. No. 13/745,236, filed Jan. 18, 2013, entitled “Method and System for a Recursive Security Protocol for Digital Copyright Control”, U.S. patent application Ser. No. 13/847,370, filed Mar. 19, 2013, entitled “Method and System for Process Working Set Isolation”, U.S. patent application Ser. No. 14/683,988, filed Apr. 10, 2015, entitled “System and Method for an Efficient Authentication and Key Exchange Protocol,” U.S. patent application Ser. No. 13/885,142, filed Apr. 2, 2013, entitled, “Method and System for Control of Code Execution on a General Purpose Computing Device and Control of Code Execution in a Recursive Security Protocol”, U.S. patent application Ser. No. 14/497,652, filed Sep. 26, 2014, entitled, “Systems and Methods for Establishing and Using Distributed Key Servers”, U.S. patent application Ser. No. 14/683,924, filed Apr. 10, 2015, entitled, “System and Method for Sharing Data Securely”, U.S. patent application Ser. No. 14/930,864, filed Nov. 3, 2015, entitled, “System and Method for a Renewable Secure Boot”, and U.S. patent application Ser. No. 14/983,051, filed Dec. 29, 2015, entitled, “System and Method for Secure Code Entry Point Control”, which are all hereby incorporated by reference in their entireties for all purposes.

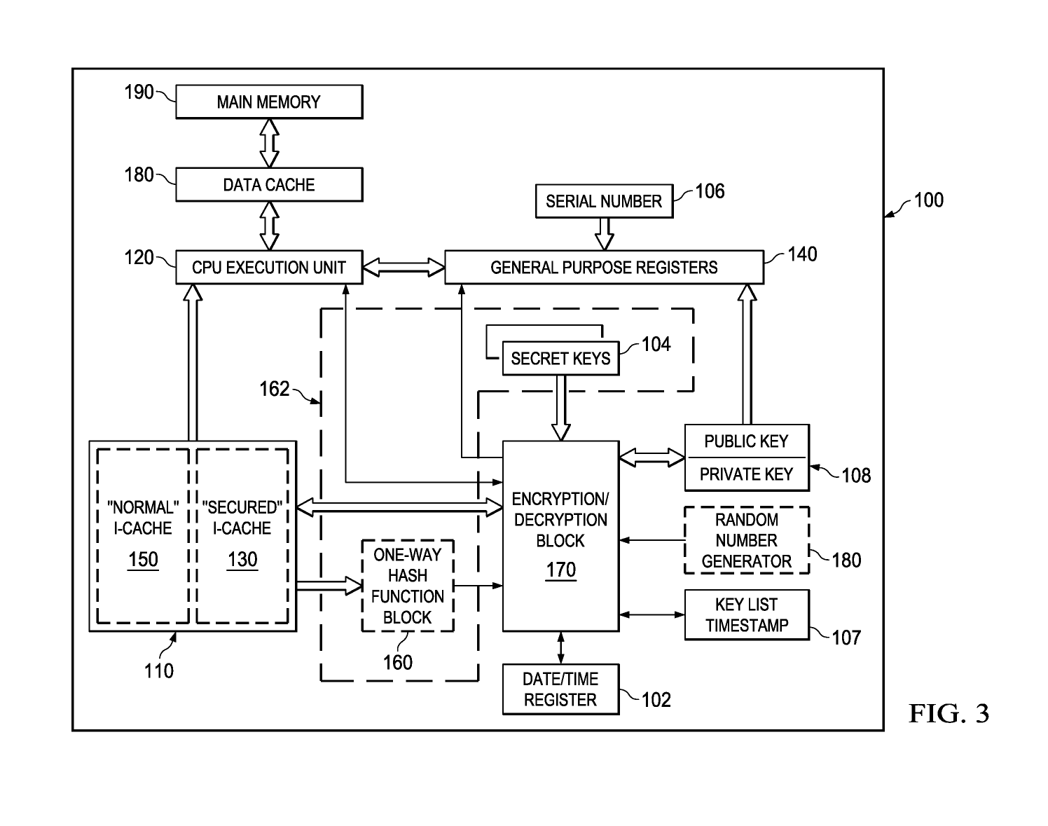

Moving now to FIG. 3, an architecture of one embodiment of a target device that is capable of controlling the execution of the digital content or implementing security protocols in conjunction with received digital content. Elements of the target unit may include a set of blocks, which allow a process to execute in a secured mode on the target device such that when a process is executing in secured mode the working set of the process may be isolated. It will be noted that while these blocks are described as hardware in this embodiment, software may be utilized to accomplish similar functionality with equal efficacy. It will also be noted that while certain embodiments may include all the blocks described herein other embodiments may utilize lesser or additional blocks.

The target device 100 may comprise a CPU execution unit 120 which may be a processor core with an execution unit and instruction pipeline. Clock or date/time register 102 may be a free-running timer that is capable of being set or reset by a secure interaction with a central server. Since the time may be established by conducting a query of a secure time standard, it may be convenient to have this function be on-chip. Another example of such a date/time register may be a register whose value does not necessarily increment in a monotonic manner, but whose value does not repeat very often. Such a register could be useful in the case where a unique timestamp value might be required for a particular reason, but that timestamp value could not necessarily be predicted ahead of time. Thus, a pseudo-random number generator may be a suitable mechanism for implementing such a register. Another option for implementing such a function would be to use the output of a hardware hash function 160 to produce the current value of this register. In the case where the output of such a hash function is used as a seed or salt value for the input of the hash function, the resulting output series may resemble a random number sequence statistically, but the values may nonetheless be deterministic, and thus, potentially predictable. Target unit 100 may also contain a true random number generator 182 which may be configured to produce a sequence of sufficiently random numbers or which can then be used to supply seed values for a pseudo-random number generation system. This pseudo-random number generator can also potentially be implemented in hardware, software or in “secure” software.

One-way hash function block 160 may be operable for implementing a hashing function substantially in hardware. One-way hash function block 160 may be a part of a secure execution controller 162 that may be used to control the placement of the target device 100 in secure mode or that may be used to control memory accesses (e.g., when the target device 100 is executing in secured mode), as will be described in more detail herein at a later point.

In one embodiment, one way has function block 160 may be implemented in a virtual fashion, by a secure process running on the very same CPU that is used to evaluate whether a given process is secure or not. In certain embodiments two conditions may be adhered to, ensuring that such a system may resolve correctly. First, the secure mode “evaluation” operation (e.g., the hash function) proceeds independently of the execution of the secure process that it is evaluating. Second, a chain of nested evaluations may have a definitive termination point (which may be referred to as the root of the “chain of trust” or simply the “root of trust”). In such embodiments, this “root of trust” may be the minimum portion of the system that should be implemented in some non-changeable fashion (e.g., in hardware). This minimum feature may be referred to as a “hardware root of trust”. For example, in such embodiments, one such hardware root of trust might be a One-Way hash function that is realized in firmware (e.g., in non-changeable software).

Another portion of the target unit 100 may be a hardware-assisted encryption/decryption block 170 (which may be referred to as the encryption system or block, the decryption system or block or the encryption/decryption block interchangeably), which may use either the target unit's 100 secret key(s) or public/private keys (described later) or a derivative thereof, as described earlier. This encryption/decryption block 170 can be implemented in a number of ways. It should also be noted that such a combination of a One-Way Hash Function and a subsequent encryption/decryption system may comprise a digital signature generator that can be used for the validation of any digital data, whether that data is distributed in encrypted or in plaintext form. The speed and the security of the entire protocol may vary depending on the construction of this block, so it may be configured to be both flexible enough to accommodate security system updates as well as fast enough to allow the system to perform real-time decryption of time-critical messages.

It is not material to embodiments exactly which encryption algorithm is used for this hardware block 170. In order to promote the maximum flexibility, it is assumed that the actual hardware is general-purpose enough to be used in a non-algorithmically specific manner, but there are many different means by which this mechanism can be implemented. It should be noted at this point that the terms encryption and decryption will be utilized interchangeably herein when referring to engines (algorithms, hardware, software, etc.) for performing encryption/decryption. As will be realized if symmetric encryption is used in certain embodiments, the same or similar encryption or decryption engine may be utilized for both encryption and decryption. In the case of an asymmetric mechanism, the encryption and decryption functions may or may not be substantially similar, even though the keys may be different.

Target device 100 may also comprise a data cache 180, an instruction cache 110 where code that is to be executed can be stored, and main memory 190. Data cache 180 may be almost any type of cache desired such as a L1 or L2 cache. In one embodiment, data cache 180 may be configured to associate a secure process descriptor with one or more pages of the cache and may have one or more security flags associated with (all or some subset of the) lines of a data cache 180. For example, a secure process descriptor may be associated with a page of data cache 180.

Generally, embodiments of target device 100 may isolate the working set of a process executing in secure mode stored in data cache 180 such that the data is inaccessible to any other process, even after the original process terminates. More specifically, in one embodiment, the entire working set of a currently executing may be stored in data cache 180 and writes to main memory 190 and write-through of that cache (e.g., to main memory 190) disallowed (e.g., by secured execution controller 162) when executing in secured mode.

Additionally, for any of those lines of data cache 180 that are written to while executing in secure mode (e.g., a “dirty” cache line) those cache lines (or the page that comprises those cache lines) may be associated with a secure process descriptor for the currently executing process. The secure process descriptor may uniquely specify those associated “dirty” cache lines as belonging to the executing secure process, such that access to those cache lines can be restricted to only that process (e.g., be by secured execution controller 162).

In certain embodiments, in the event that the working set for a secure process overflows data cache 180 and portions of data cache 180 that include those dirty lines associated with the security descriptor of the currently executing process need to be written to main memory (e.g., a page swap or page out operation) external data transactions between the processor and the bus (e.g., an external memory bus) may be encrypted (e.g., using encryption block 170 or encryption software executing in secure mode). The encryption (and decryption) of data written to main memory may be controlled by secure execution controller 162.

The key for such an encryption may be the secure process descriptor itself or some derivative thereof and that secure descriptor may itself be encrypted (e.g., using the target device's 100 secret key 104 or some derivative thereof) and stored in the main memory 190 in encrypted form as a part of the data being written to main memory.

Instruction cache 110 is typically known as an I-Cache. In some embodiments, a characteristic of portions of this I-Cache 110 is that the data contained within certain blocks be readable only by CPU execution unit 120. In other words, this particular block of I-Cache 130 is execute-only and may not be read from, nor written to, by any executing software. This block of I-Cache 130 will also be referred to as the “secured I-Cache” 130 herein. The manner by which code to be executed is stored in this secured I-Cache block 130 may be by way of another block which may or may not be depicted. Normal I-Cache 150 may be utilized to store code that is to be executed normally as is known in the art.

Additionally, in some embodiments, certain blocks may be used to accelerate the operation of a secure code block. Accordingly, a set of CPU registers 140 may be designated to only be accessible while the CPU 120 is executing secure code or which are cleared upon completion of execution of the secure code block (instructions in the secured I-cache block 130 executing in secured mode), or if, for some reason a jump to any section of code which is located in the non-secure or “normal” I-Cache 150 or other area occurs during the execution of code stored in the secured I-Cache 130.

In one embodiment, CPU execution unit 120 may be configured to track which registers 140 are read from or written to while executing the code stored in secured I-cache block 130 and then automatically clear or disable access to these registers upon exiting the “secured execution” mode. This allows the secured code to quickly “clean-up” after itself such that only data that is permitted to be shared between two kinds of code blocks is kept intact. Another possibility is that an author of code to be executed in the secured code block 130 can explicitly identify which registers 140 are to be cleared or disabled. In the case where a secure code block is interrupted and then resumed, then these disabled registers may potentially be re-enabled if it can be determined that the secure code that is being resumed has not been tampered with during the time that it was suspended.

In one embodiment, to deal with the “leaking” of data stored in registers 140 between secure and non-secure code segments a set of registers 140 which are to be used only when the CPU 120 is executing secured code may be identified. In one embodiment this may be accomplished utilizing a version of the register renaming and scoreboarding mechanism, which is practiced in many contemporary CPU designs. In some embodiments, the execution of a code block in secured mode is treated as an atomic action (e.g., it is non-interruptible) which may make this such renaming and scoreboarding easier to implement.

Even though there may seem to be little possibility of the CPU 120 executing a mixture of “secured” code block (code from the secured I-Cache 130) and “unsecured code” (code in another location such as normal I-cache 150 or another location in memory), such a situation may arise in the process of switching contexts such as when jumping into interrupt routines, or depending on where the CPU 120 context is stored (most CPU's store the context in main memory, where it is potentially subject to discovery and manipulation by an unsecured code block).

In order to help protect against this eventuality, in one embodiment another method which may be utilized for protecting the results obtained during the execution of a secured code block that is interrupted mid-execution from being exposed to other execution threads within a system is to disable stack pushes while a the target device 100 is operating in secured execution mode. This disabling of stack pushes will mean that a secured code block is thus not interruptible in the sense that, if the secured code block is interrupted prior to its normal completion, it cannot be resumed and therefore must be restarted from the beginning. It should be noted that in certain embodiments if the “secured execution” mode is disabled during a processor interrupt, then the secured code block may also potentially not be able to be restarted unless the entire calling chain is restarted.

Each target unit 100 may also have one or more secret key constants 104; the values of neither of which are software-readable. In one embodiment, the first of these keys (the primary secret key) may be organized as a set of secret keys, of which only one is readable at any particular time. If the “ownership” of a unit is changed (for example, the equipment containing the protocol engine is sold or its ownership is otherwise transferred), then the currently active primary secret key may be “cleared” or overwritten by a different value. This value can either be transferred to the unit in a secure manner or it can be already stored in the unit in such a manner that it is only used when this first key is cleared. In effect, this is equivalent to issuing a new primary secret key to that particular unit when its ownership is changed or if there is some other reason for such a change (such as a compromised key). A secondary secret key may be utilized with the target unit 100 itself. Since the CPU 120 of the target unit 100 cannot ever access the values of either the primary or the secondary secret keys, in some sense, the target unit 100 does not even “know” its own secret keys 104. These keys are only stored and used within the security execution controller 162 of the target unit 100 as will be described.

In another embodiment, the two keys may be constructed as a list of “paired” keys, where one such key is implemented as a one-time-programmable register and the other key in the pair is implemented using a re-writeable register. In this embodiment, the re-writeable register may be initialized to a known value (e.g., zero) and the only option that may be available for the system to execute in secure mode in that state may be to write a value into the re-writeable portion of the register. Once the value in this re-writeable register is initialized with some value (e.g., one that may only be known by the Licensing Authority, for example), then the system may only then be able to execute more general purpose code while in secure mode. If this re-writeable value should be re-initialized for some reason, then the use of a new value each time this register is written may provide increased security in the face of potential replay attacks.

Yet another set of keys may operate as part of a temporary public/private key system (also known as an asymmetric key system or a PKI system). The keys in this pair may be generated on the fly and may be used for establishing a secure communications link between similar units, without the intervention of a central server. As the security of such a system is typically lower than that of an equivalent key length symmetric key encryption system, these keys may be larger in size than those of the set of secret keys mentioned above. These keys may be used in conjunction with the value that is present in the on-chip timer block in order to guard against “replay attacks”, among other things. Since these keys may be generated on the fly, the manner by which they are generated may be dependent on the random number generation system 180 in order to increase the overall system security.

In one embodiment, one method that can be used to affect a change in “ownership” of a particular target unit is to always use the primary secret key as a compound key in conjunction with another key 107, which we will refer to as a timestamp or timestamp value, as the value of this key may be changed (in other words may have different values at different times), and may not necessarily reflect the current time of day. This timestamp value itself may or may not be itself architecturally visible (e.g., it may not necessarily be a secret key), but nonetheless it will not be able to be modified unless the target unit 100 is operating in secured execution mode. In such a case, the consistent use of the timestamp value as a component of a compound key whenever the primary secret is used can produce essentially the same effect as if the primary secret key had been switched to a separate value, thus effectively allowing a “change of ownership” of a particular target endpoint unit without having to modify the primary secret key itself.

Embodiments of the invention provide a simple and effective method for authentication and activation in a device assembly. An exemplary assembly may include one or more semiconductor devices assembled on a motherboard or module by a systems integrator. The assembled device may ultimately be activated by a service provider and used by a user to run one or more application developed by a software vendor. For the device to function securely, the various components and systems (e.g., semiconductor manufacturer, systems integrator, service provider, software vendor, user, etc.) used in a given task must cooperate, even though underlying entities may not share trust among one another. One important benefit of the mechanisms described is that the data encryption used by the system can be accomplished without using asymmetric encryption, which is inefficient and processor intensive. For example, in the mechanisms described below, the data encryption can be accomplished using symmetric encryption, which is much more efficient than asymmetric encryption.

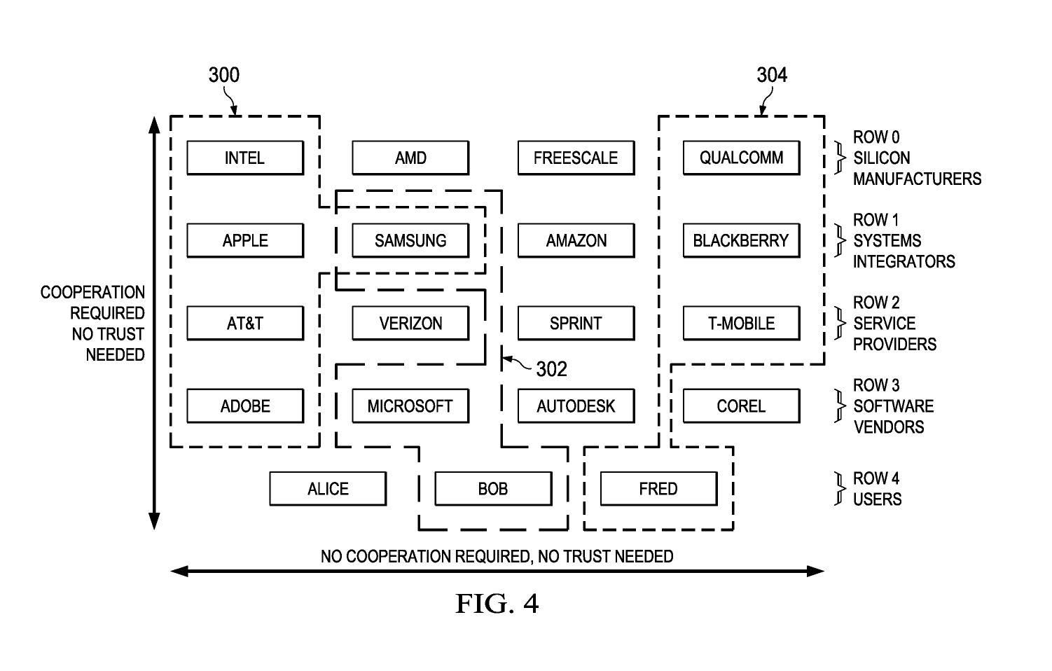

FIG. 4 is a block diagram illustrating system-wide relationship examples of an exemplary system like that described above. FIG. 4 shows a plurality of rows (Row 0 through Row 4, in this example), each representing different parts of a system. Row 0 shows examples of silicon manufacturers (e.g., Intel, AMD, Freescale, Qualcomm, etc.) that manufacture semiconductor devices, such as CPUs, microcontrollers, etc. The silicon manufacturers are typically competitors, and are unlikely to cooperate or to trust one another. Row 1 shows examples of systems integrators (e.g., Apple, Samsung, Amazon, Blackberry, etc.), that build devices on a motherboard or module using one or more of the silicon devices supplied by a manufacturer (e.g., one of the entities in Row 0). Like the silicon manufacturers, the systems integrators are typically competitors, and are unlikely to cooperate or to trust one another. Row 2 shows examples of service providers (e.g., AT&T, Verizon, Sprint, T-Mobile, etc.), that may be used with a given device. Like the silicon manufacturers and systems integrators, the service providers are typically competitors, and are unlikely to cooperate or to trust one another. Row 3 shows examples of software vendors (e.g., Adobe, Microsoft, Autodesk, Corel, etc.) that provide software to run on a given device. Like the silicon manufacturers, systems integrators, and service providers, the software vendors are typically competitors, and are unlikely to cooperate or to trust one another. Row 4 shows examples of users (e.g., Alice, Bob, Fred, etc.) of devices. While users may not be competitors, users have an expectation of privacy, and do not typically want to cooperate with or trust other users.

FIG. 4 also shows examples of several security boundaries that surround components of a given device that work together. The components within each given security boundary need to cooperate with one another, although trust is not required. In other words, each party within a security boundary needs to cooperate together, but will still not want to share their private secrets with the others, although they do share a common secret (the newly-created secret that defines the security layer, described below).

A first security boundary 300 represents a device having an Intel chip on a Samsung phone running an Adobe application (for example, viewing a flash video) over an AT&T network. A second security boundary 302 represents a Samsung device used by user Bob, running a Microsoft application. A third security boundary 304 represents a Blackberry device using a Qualcomm processor, used by user Fred on a T-Mobile network.

In each of the examples above (represented by Security Boundaries 300, 302, and 304), an activation mechanism is used to securely authorize the device to execute a given process, without sharing secrets with other components outside the boundary. In other words, one goal is to provide a shared secret that is shared in a given security boundary. In some embodiments, the shared secret is generated by the device, but is not known by the device (i.e., a “zero knowledge secret”). Several examples of activation mechanisms are provided below.

As an example, referring to security boundary 302, assume a device built by systems integrator Samsung has secure data that it need to share with an application developed by software vendor Microsoft, for use by user Bob. In this example, secure boundary 302 is created, including systems integrator Samsung, software vendor Microsoft, and user Bob. Each entity wishes to keep certain data private, but has a need to share secure data when Bob runs the Microsoft application on the Samsung phone. It is desired to encrypt data that can be only be decrypted by these three entities working together, but not decrypted by each individually. As described in detail below, a key is created that is known by all three entities, but not re-creatable by each individually. In the prior art, in such a scenario, threshold encryption (i.e., asymmetric encryption, or key splitting) techniques are typically used. While this works, asymmetric cryptography is very inefficient.

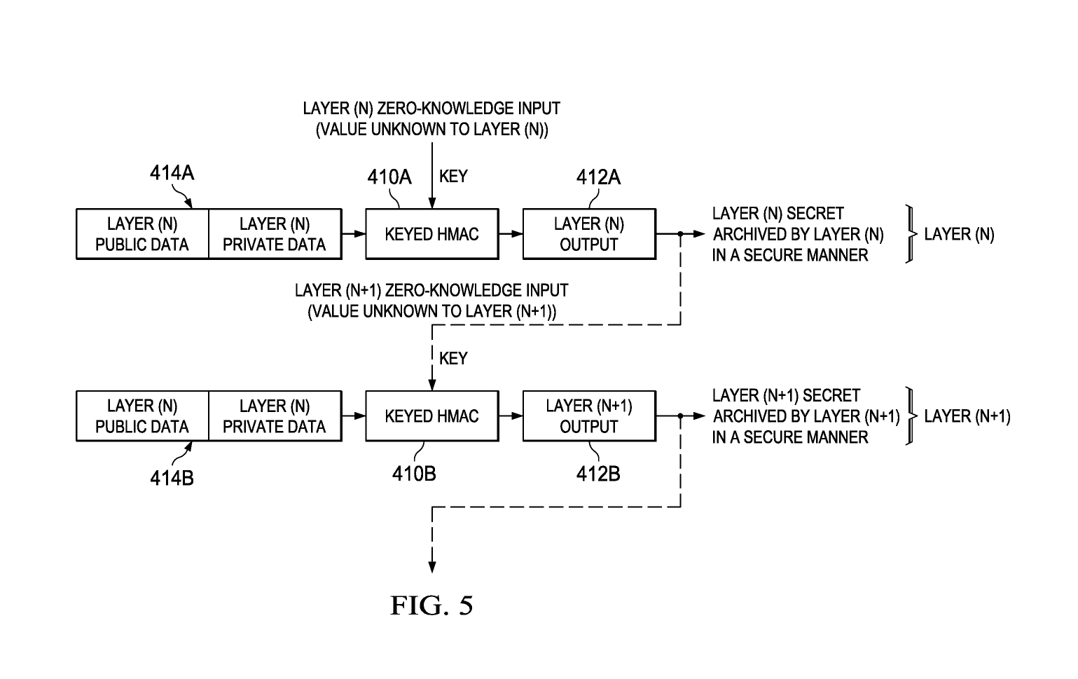

FIG. 5 illustrates a first example of a cryptographic hierarchical activation mechanism.

The hierarchical activation mechanism can be thought of in terms of “layers”, where each layer may represent a security boundary, such as those shown in FIG. 4. When a device executes a new secure operation, a new layer is formed, and the hierarchical activation mechanism generates a new secret that will be used in the respective new layer, but will not be available to other layers.

FIG. 5 shows a first layer (N) and a second layer (N+1). In each layer, a hardware keyed hash message authentication code (HMAC) 410A, 410B calculates a message authentication code (MAC) 412A, 412B based on input data 414A, 414B and a key (layer (N) zero-knowledge input and layer (N+1) zero-knowledge input (values unknown to each respective layer)). In the example shown, the input data 414A includes Layer (N) public data and optional Layer (N) private data. The Layer (N) and Layer (N+1) private data may come from a source of entropy (e.g., noise, random number, etc.) or from a private source, or any other desired source.

Similarly, the input data 414B includes Layer (N+1) public data and optional Layer (N+1) private data. In some embodiments, the public data may be received from a service, and/or stored in memory in the clear. If private data (i.e., data that is not visible to any other layer) is used in the derivation of a layer's secret, then the resulting secret is not knowable by any other layer (even including a higher (N−m) layer). The output of the keyed HMAC 410A is stored as the layer (N) output 412A. This “layer (N) secret” is archived by layer (N) in a secure manner. Note that knowledge of the layer (N) secret won't reveal useful information for higher level secrets.

The layer (N) secret is provided to layer (N+1) as the key input to the keyed HMAC 410B for layer (N+1) to generate layer (N+1) output 412B, which becomes the “layer (N+1) secret”. Note that, the Layer (N) process is given the ability to overwrite the key for Layer (N+1). If the layer (N+1) input data 414B includes private data that is not visible to any other layer, then the layer (N+1) secret will not be knowable by any other layer. This same mechanism can be applied to as many layers as desired.

Also note that, for a given layer, if all of the input data is private data, then the data decryption is repeatable, so the entities in the given layer can get back together. Alternatively, if the key includes a non-repeatable nonce, then every time that a new processes launched, a new nonce is used, making the process a one-time process, since the previous nonce will not be known by any of the entities. One example where a it may be desirable to use a nonce is in conjunction with a money transfer. In the example of a money transfer, you want to the transfer to be authorized once, but you do not want the process repeatable.

Following is a description of a basic activation (secret creation) sequence, according to the example shown in FIG. 5. FIGS. 10-13, discussed below, provide more details regarding the implementation of an activation sequence. First, a client device requests permission to execute a secure operation (Sec_Op) using the resources belonging to a “service”. This permission requires the creation of a “layer secret” (described above) that can be used by the client during the secure operation (in a newly-defined security layer), but whose value is not discoverable by the client while operating at that layer. The service responds to the client device with two pieces of data (in the clear). A first piece of data is a precursor that may be used (possibly along with other input data (e.g., input data 414A in FIG. 5)) to generate a new private secret (e.g., Layer (N) output 412A in FIG. 5, which becomes the Layer (N+1) key) on the client device. This new private secret is known only to the device if there is more than one piece of input data that is used in the creation of this secret. A second piece of data is a second precursor that may either be used a) as a precursor to a signature that is calculated on the newly-created private key or b) as a precursor to create an encryption key, so that this newly-created private secret can be returned to the service in a secure fashion. Note that, in the case where the only input that is used to generate the new private secret is that which was provided by the service, then the service can calculate the private secret independently of the device, but in this case the second piece of service-provided data (the precursor) is used to create a signature of the newly-created private secret by the device. This signature is then returned to the service by the device as a verification that the device and the service both agree on the value of the newly-created private secret.

Next, the client device acknowledges the response by sending either an encrypted copy of the newly-created device secret or the signature of the newly-created secret (since the service should already know the secret in this case, the signature is simply the confirmation that the device and the service are in sync). The overall transmission may be signed by the client device with the old (previously existing) device secret in both cases. The service may then confirm receipt of the new device secret by sending the client device a response to indicate that the two are in agreement. This response may be in the form of an Authcode that may permit the device to write the new device secret value to its Kh shadow register. If the service cannot verify the signature, or if the request is otherwise deemed invalid, then the service should indicate this by responding to the device with a (signed) message. This signed message may include a command to force the client device to perform a factory reset (e.g., loading Kh_otp to the Kh shadow register) or it simply may not provide a valid Authcode for the shadow register write operation, in which case the device may simply never leave its current security layer.

There are a number of mechanisms that could be used to accomplish this “stay in the same security layer” effect. For example, the client device may exit the Sec_Op, which may cause the Kh register to be written with the value of the Kh shadow register. If the shadow register has not been overwritten by some new value (and it retains its value since the last time it was written to in a secure manner), then the effect may be the same as if the device simply stayed in the existing security layer. Another method by which this same result may be accomplished is to force the device to reset back to the default “power-up” state, at which point, the device may then have to “retrace its steps” to get back to the previous state (effectively returning the device back to the same security layer that it was in when the original secure operation failed).

As described above with respect to FIG. 5, each “parent layer” (for example, layer (N)) may supply a subsequent (descendent) layer (for example, layer (N+1)) two capabilities: (1) a secret (e.g., the layer (N) secret), and (2) the ability (through an Authcode) to replace the secret with the layer's own secret (e.g., the layer (N+1) secret). As soon as the secret is replaced, as stated earlier, this effectively means that the system has entered a new security layer (e.g., the device has transitioned from layer (N) to layer (N+1)). This effect of this transition is also equivalent to transforming the device from one virtual device into another, entirely different device. Also, as noted above, if layer (N+1) private data is included in the input to the keyed HMAC 410B, then the new secret (Layer (N+1) secret) will only be known to the current layer, effectively cutting off the ability of all parent layers to either control the device (by providing Authcodes) or to decrypt any messages that the device produces in its “new” state.

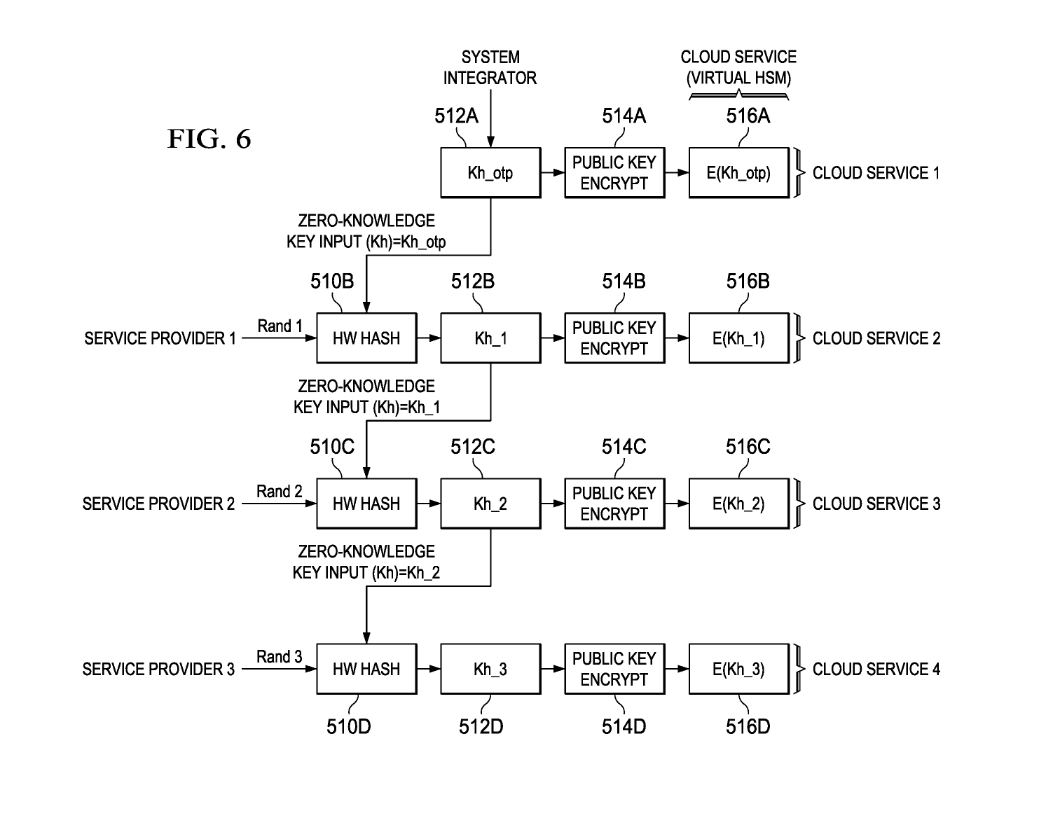

FIG. 6 contains a diagram illustrating an example of how a hierarchical device management system might operate in a cloud service environment. Generally, the system works as follows. The device authenticates based on something that the device contains, but does not know. That value is the device key and is stored in a zero-knowledge register (Kh). The value of the device key stored in the zero-knowledge register Kh can never be read. The device key stored in the zero-knowledge register Kh can be overwritten only by a correctly authorized Secure_Operation (Sec_Op). Such a Sec_Op can only be authorized by an entity that knows the current value of Kh. Once the value of the device key stored in the zero-knowledge register Kh is changed, then all previously-authorized Sec_Ops (based on prior values in Kh) are no longer authorized (i.e., the prior Authcodes are no longer valid).

The example shown in FIG. 6 includes four layers (e.g., four security boundaries, such as those shown in FIG. 4). In the initial layer, the device key is Kh_otp stored in register 512A. In this example, the initial value is derived from a hardware secret. The device key is encrypted at encryption block 514A using the device secret and a device serial number to generate output 516A E(Kh_otp) and is provided to Cloud Service 0. Cloud Service 0 knows Kh_otp and can manage the device at all points.

The device secret is provided to hardware hash 510B as the zero-knowledge key input (Kh)=(Kh_otp) with a random number Rand 1 (from Service Provider 1) as the input data. The output of the hash function 510B is the newly-generated device secret Kh_1, and that value is stored in register 512B. This new device secret Kh_1 may then be encrypted at block 514B using the public key of Cloud Service 1 (and optionally signed with the device's existing secret and/or serial number) to generate output 516B E(Kh_1), which can then be sent to Cloud Service 1. Note that this new device secret (Kh_1) value can also be shared with some other entity, for example Cloud Service 2 (or even the same device itself if it is in some other security layer), by encrypting the value Kh_1 with the public key of that other entity. After decrypting the message with its private key, Cloud Service 1 now knows Kh_1 and can manage the device at all points from Kh=Kh_1 and below, without ever knowing the value of Kh_otp.

The device secret (Kh_1) can be provided to hardware hash 510C as the zero-knowledge key input (Kh)=(Kh_1) with a random number Rand 2 (from Service Provider 2) as the input. The output of the hash 510C is the new device secret Kh_2, and that is stored in register 512C. This new device secret Kh_2 may then be encrypted using the public key of Cloud Service 2 (and optionally signed with the device's existing secret and/or serial number) to generate E(Kh_2) and this value can then be sent to Cloud Service 2. After decrypting the message at block 514C to generate output 516C E(Kh_2) with its private key, Cloud Service 2 now knows Kh_2 and can manage the device at all points from Kh=Kh_2 and below, without ever knowing the value of either Kh_otp or Kh_1.

The device secret (Kh_2) can be provided to hardware hash 510D as the zero-knowledge key input (Kh)=(Kh_2) with a random number Rand 3 (from Service Provider 3) as the input. The output of the hash 510D is the new device secret Kh_3, and is stored in register 512D. This new device secret Kh_3 may then be encrypted at block 514D using the public key of Cloud Service 3 (and optionally signed with the device's existing secret and/or serial number) to generate output 516D E(Kh_3) and this value can then be sent to Cloud Service 3. After decrypting the message with its private key, Cloud Service 3 now knows Kh_3 and can manage the device at all points from Kh=Kh_3 and below, without ever knowing the value of anything other than Kh_3.

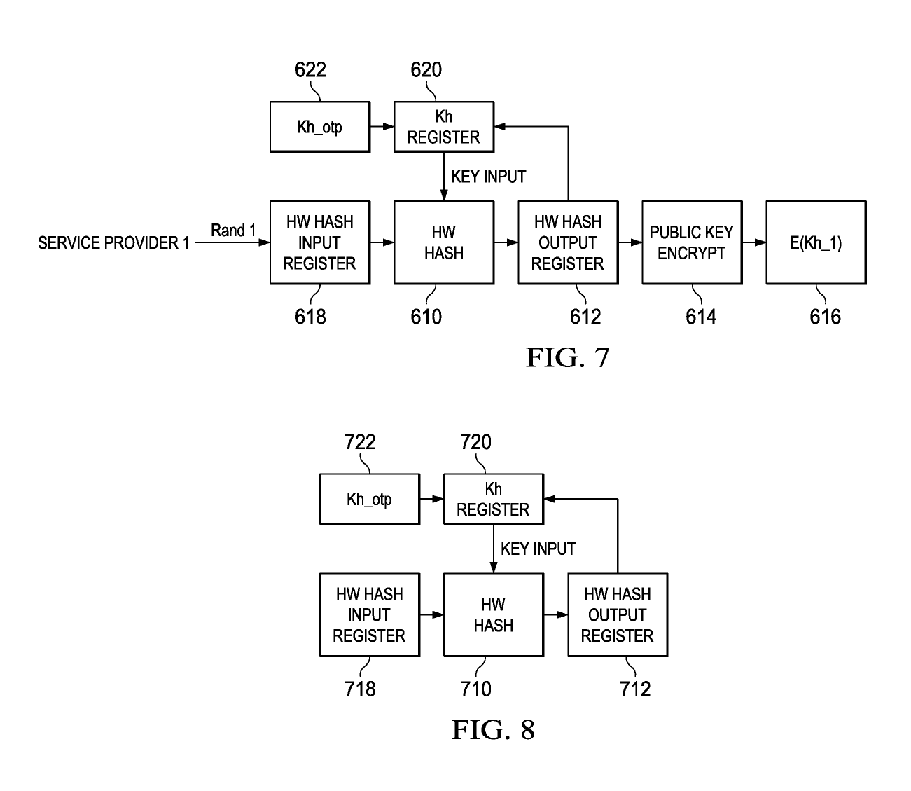

FIG. 7 is a diagram illustrating an example of a device hierarchical activation authorization sequence (from power-on to Kh=Kh_1). As shown in FIG. 7, a hardware hash 610 receives a key input from Kh register 620, and input data from hardware hash input register 618. The data in the input register 618 includes random number Rand 1 from service provider 1. Initially, at power-up, Kh register 620 is loaded with Kh_otp (the hardware secret) from register 622. The output of hash 610 is stored in hardware hash output register 612. Hardware hash output register 612 provides an update input to Kh register 620, as described below. The data stored in hardware hash output register 612 is also encrypted at public key encrypt block 614 to generate output 616 E(Kh_1), as is described above with respect to FIG. 5.

Generally, the system works as follows. At power-on, Kh register 620 is loaded with the Kh_otp value from register 622. A public Authcode is written into an Authcode register (not shown) and random number Rand1 (also public) is written into the HW hash input register 618. The processor then attempts to execute a secure operation (Sec_Op) to create a new Kh value, using the random number Rand 1 and the public key of Service Provider 1 as inputs. If the Authcode is correct for the Sec_Op, then the processor executes the Sec_Op in secure mode. First, the output of the HW hash 610 is generated (Kh_1) and stored in output register 612 using the keyed hash of Kh_otp and Rand 1. The HW hash output is encrypted with using the public key for Cloud Service 1, resulting in output 616 E(Kh_1), which can be published.

If the Authcode used is not correct, then processor will not execute in secure mode. In this case, the output of HW hash 610 will be is something other than the “correct” Kh_1 (i.e., HW hash output≠Kh_1). The HW hash 610 output may (or may not) be encrypted at block 614 with the public key of Service Provider 1 and sent to Service Provider 1.

Next, a second Authcode (public) is written into the Authcode register and random number Rand1 is written into HW hash input register 618 (again, if necessary). Then, the processor attempts to run the second Sec_Op (e.g., write a new Kh). If the second Authcode is correct for the Sec_Op, then the processor executes the Sec_Op in secure mode. First, the output of the HW hash 610 is generated (Kh_1) and stored in output register 612 using the keyed hash of Kh_otp and Rand1 (i.e., the “correct” value of Kh_1 is recreated) and the Kh register 620 is updated with the (“correct”) value of Kh_1. Since the Kh register 620 has changed, and the processor drops out of secure mode. Now, the service provider knows the value of the Kh register 620, even though the target device may no longer be able to access the value of Kh_1 that it just created, since it is no longer operating in secure mode.

If desired (e.g., see FIG. 6), multiple iterations of this process can be used to generate a pseudorandom sequence of Kh values. All of the Kh values are generated using public input, but even knowing the public input an external observer cannot determine what the result will be from another step unless they also know the (secret) “seed” for any particular Kh value. As a result, referring again to security boundary 302 of FIG. 4, Samsung, Microsoft, and Bob can together create a secret that these three entities all know the conditions that are required to recreate (since they all know the public inputs) as well as the shared secret itself, even though none of the entities may know what the “seed” secret is that is originally used to create the derived secret they are sharing.

If the second Authcode is not correct, then processor will not execute in secure mode. In this case, the output of HW hash 610 will be is something other than the “correct” Kh_1 (i.e., HW hash output≠Kh_1) and the Kh register 620 is not updated (i.e., Kh register retains the previous value of Kh, in this case, Kh remains at Kh_otp.

Returning to FIG. 6., we can show one of several methods by which a distributed hierarchical device activation mechanism (such as was illustrated in FIG. 4) can be accomplished with a cloud service group and three service providers. In this first exemplary method, Cloud Service 1 (who knows Kh_otp) provides the appropriate Authcode (based on the value of Kh_otp) to Service Provider 1 that allows it to create a new Kh value (in this case, Kh_1). The devices then encrypts the newly-created Kh_1 with Cloud Service 2's public key. This encrypted version of Kh_1 is now known only to Cloud Service 2. Cloud Service 2 then provides the appropriate Authcode to the device that allows Service Provider 2 (who does not know Kh_1) to cause the device to create a new Kh value (Kh_2). As in the previous step, this value of Kh_2 is then encrypted with Cloud Provider 3's public key. This procedure can be repeated as many times as required in order to generate a final Kh value;—in this case, one that is known only to Cloud Service 4. This resulting (Kh_3) value can then be shared by Cloud Service 4 with whomever it wishes to have the ability to control the device when it is in secure mode (as defined by the device having the value of Kh_3 in the register that provides the secret key input to the HMAC function).

When the device power on, the value of Kh register 620 is Kh=Kh_otp. In this example, assume that the device is running the follow Sec_Ops in sequence: Sec_Op 1B (input=Rand 1), Sec_Op 2B (input=Rand 2), and Sec_Op 3B (input=Rand 3). As described above with respect to FIG. 6, the device after running the three Sec_Ops the device now has Kh_3 provisioned in its zero knowledge key register Kh, although the device doesn't know its value at the current security layer (that is defined by the presence of Kh_3 in the zero knowledge register). Any external observers can cause the device to load the specific value of Kh_3 into its secret key register, but only those who know the value that is contained therein (e.g., Kh_3 in this example) can control the device's operation when it is in secure mode.

Cloud Service 1 has several ways that it can acquire Kh_3. In one example, Cloud Service 1 can calculate Kh_3 as follows:
Kh_3=Hash (Hash (Kh_1, Rand 2), Rand 3))
Cloud Service 1 knows Kh_1 from Sec_Op 1B.

In another example, Cloud Service 3 can send the value of Kh_3 to other Cloud Services by encrypting it.

Cloud Service 2 can calculate Kh_3 as follows:
Kh_3 32 Hash (Kh_2, Rand 3))
Cloud Service 2 knows Kh_2 from Sec_Op 2B.

Cloud Service 3 already knows Kh_3 from Sec_Op 3B. Now, all Cloud Service Groups know Kh_3. However, none of these Cloud Service providers know Kh_otp.

FIG. 8 is a diagram illustrating an example of a device Kh value update sequence (from power-on to Kh=Kh_3). As shown in FIG. 7, a hardware hash 710 receives a key input from Kh register 720, and input data from hardware hash input register 718. Initially, Kh register 720 is loaded with Kh_otp from register 722. The output of HW hash 710 is stored in hardware hash output register 712. Hash output register 712 provides an update input to Kh register 720, as described above.

Generally, the system works as follows. At power-on, the Kh register 720 is loaded with the Kh_otp value from register 722. An Authcode (public) is written into an Authcode register (not shown) and random number Rand 1 (also public) is written into the HW hash input register 718. The processor attempts to run a Sec_Op to write a new Kh value. If the Authcode is correct for the Sec_Op, then the processor executes the Sec_Op in secure mode. First, the output of the HW hash 610 is generated (Kh_1) and stored in output register 712 using the keyed hash of Kh_otp and Rand 1 (i.e., the “correct” value of Kh_1 is recreated). If the Authcode is not correct, then the Kh register 720 retains the value of Kh_otp).

Next, a second Authcode (public) is written into the Authcode register and random number Rand 2 (public) is written into the HW hash input register 718. Then, the processor attempts to run the second Sec_Op (to write a new Kh). The second Sec_Op is the same as above, but with a different authcode and a different input (Rand 2). If the second Authcode is correct for the Sec_Op, then the output of the HW hash 710 is generated and stored in the output register 712 using the keyed hash of Kh_1 and Rand 2 (i.e., the “correct” value of Kh_2 is recreated) and the Kh register 720 is updated with the (“correct”) value of Kh_2. If the second Authcode is not correct, then the Kh register is not changed.

Next, a third) Authcode (public) is written into the Authcode register and random number Rand 3 (public) is written into the HW hash input register 718. Then, the processor attempts to run the third Sec_Op (to write a new Kh), just as before. If the third Authcode is correct for the Sec_Op, then the output of the HW hash 710 is generated and stored in the output register 712 using the keyed hash of Kh_2 and Rand 3 (i.e., the “correct” value of Kh_3 is recreated) and the Kh register 720 is updated with the (“correct”) value of Kh_3. Note that this entire process is accomplished using public input data and a single secret (Kh_otp).

Following is a further example of a device distributed activation process. In this example, the requirements for distributed activation include: the activation must create a zero knowledge key; this key must be mirrored between all members of the cloud service group and the device' any number of parties may participate in activation (the group must be agreed upon prior to beginning activation process); any one of the participating parties may authorize secure operations and/or a perform key exchange; all parties must cooperate if they wish to participate; and zero trust is required between the parties.

In this distributed device activation example, the activation is a “Flat Group” device activation. First, device Q1 Powers on (Kh=Kh_otp). Assume that device Q1 runs the following Sec_Ops in sequence (from the previous examples):
Sec_Op 1B (input=Rand 1) (Authcode based on Kh_otp),
Sec_Op 1B (input=Rand 2) (Authcode based on Kh_1),
Sec_Op 1B (input=Rand 3) (Authcode based on Kh_2).

As before, device Q1 now has Kh_3 provisioned in its zero knowledge key register Kh (the value of which is known by service provider 3). Service provider 3 can now create a secure group ABC (including service providers A,B,C). The group members can all share a new zero-knowledge key (Kh_4). In this example, service provider 3 is the “group creator”, but may or may not be a group member.

Device Q1 can create Kh_4 (and load it into the Kh register) using the following invocation of Sec_Op 1B: Sec_Op 1B (input={Rand A, Rand B, Rand C, Int_nonce}), where Rand A B & C are provided by the individual members of the newly formed secure group ABC and nonce Int_nonce is a value that is known only to device Q1. Service provider 3 can create the proper Authcode for this “group formation” Sec_Op 1B (based on Kh_3). This Sec_Op causes device Q1 to load Kh_4 into its Kh register, thus making it no longer controllable by service provider 3 (since it now has a new zero knowledge key, Kh_4). Any entity who knows the value of Kh_4 can now manage and/or perform key translations for device Q1. But, since device Q1 is the only entity that knows the value of Int_nonce, then not even service provider 3 can know the value of Kh_4.

Device Q1 can then send the value of Kh_4 (in encrypted form) to the secure group by several methods. One simple method is to encrypt Kh_4 with the public keys of A, B & C. At that point, all members of the secure group ABC will know Kh_4 and any one of them can create Authcodes and/or translate keys for device Q1, at least until the value of Kh_4 expires. Note that service provider 3 does not know the value of Kh_4 and it also has not had to share the value of Kh_3 with secure group ABC members.

Note that if any one of the group members is the manager of any other device (e.g.,

Device Q2, one that is not managed by any other member of the original secure group), then that secure group member can act as a gateway to provide key exchange services between devices Q1 and Q2, even though device Q2 may not be a part of the original secure group ABC.

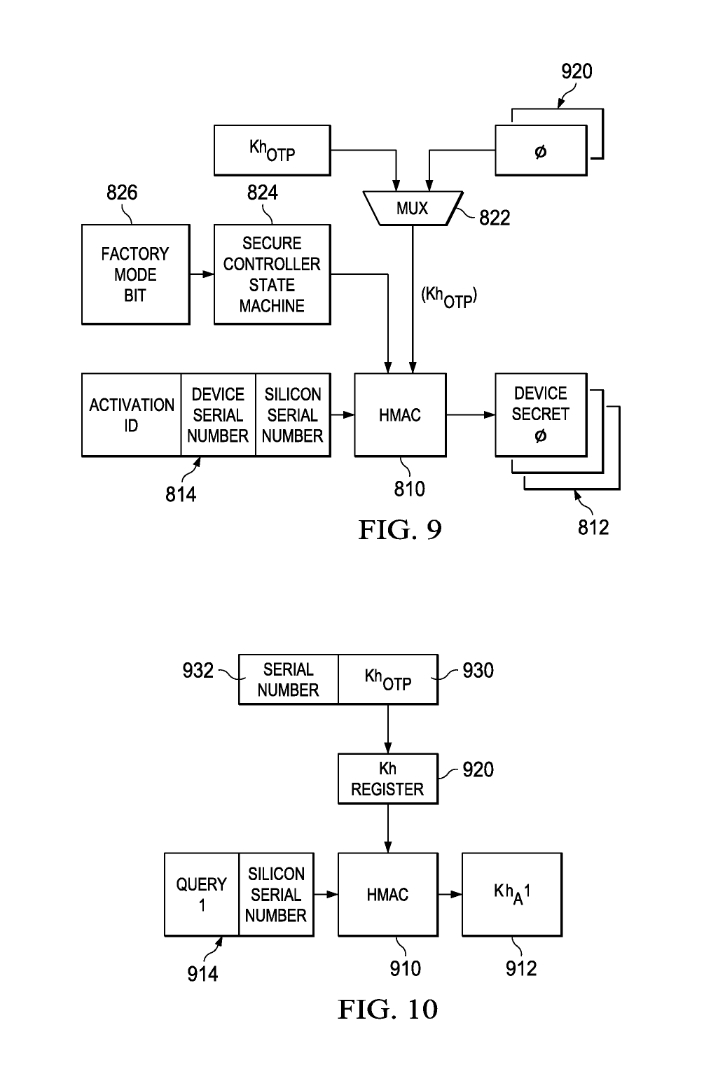

FIG. 9 is a block diagram illustrating another example of distributed device activation. As in the other examples, FIG. 9 shows a keyed HMAC 810 that calculates a device secret 812 based on data input 814 and a key input. In this example, the data input 814 is derived from the silicon serial number, the device serial number, and an activation ID (or nonce). The silicon serial number is a serial number permanently stored in the silicon device at the factory. The device serial number is a serial number of the device assembled by the system integrator. The activation ID is supplied by an activation service, and can be a static ID, or a nonce.

A device secret Kh_otp (known only to the silicon manufacturer) and the value (KhA) stored in a shadow register 820 (described above with respect to FIGS. 6-7) are provided to MUX 822 to generate the key input for the HMAC 810. The shadow register 820 is initially set to 0. Since the shadow register 820 is initially 0, the key input will initially be Kh_otp.

FIG. 9 also shows a factory mode bit 826. The device secret 812 can only be exported by the device when the factory mode bit=0. Once the factory mode bit=1, the device secret cannot be exported, only used inside a secure operation, based on secure controller state machine logic 824.

FIGS. 10-13 show additional examples of distributed device activation mechanisms.

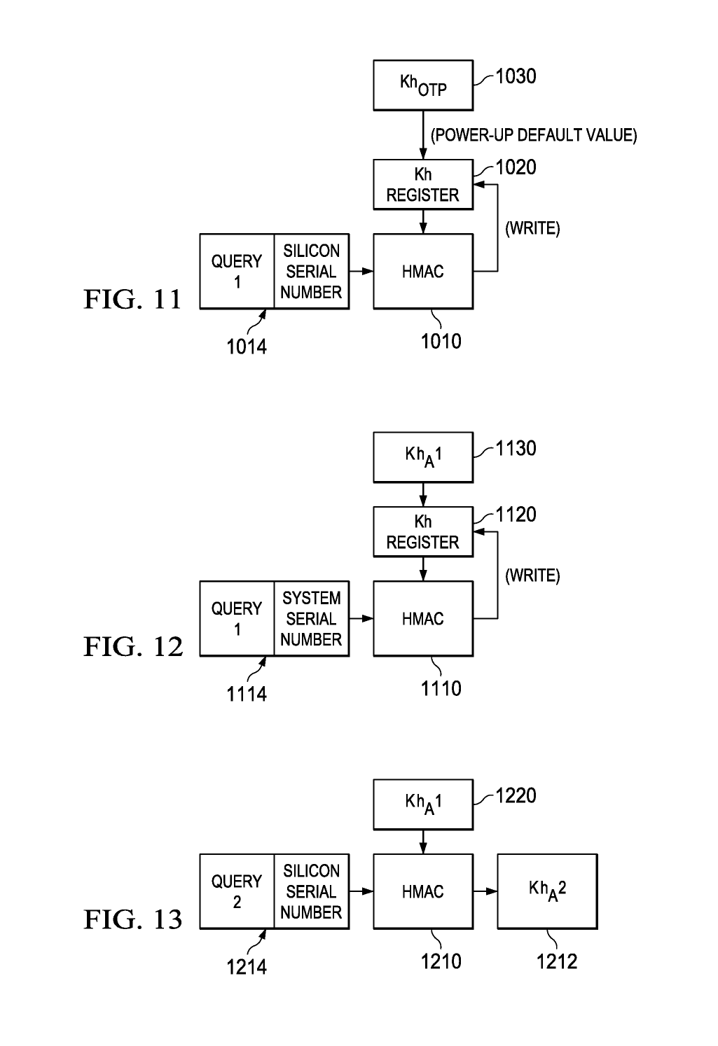

FIGS. 10-11 show the operation at a silicon fab. FIG. 10 shows the operation of reading KhA1. As shown in FIG. 10, a keyed HMAC 910 receives a key input from Kh register 920, and input data from input register 914. The data in the input register 914 includes a silicon serial number and a query from a system integrator. The Kh register 920 has value derived from hardware secret Kh_otp 930 and a device serial number 932. The output of HMAC 710 (KhA1) is stored in output register 912. The secret KhA1 is a secret belonging to the fab only.

FIG. 11 shows the operation of writing KhA1 to the Kh register. Like FIG. 10, FIG. 11 shows a keyed HMAC 1010, Kh register 1020, and input register 1014. As shown, the output of HMAC 1010 (KhA1) is written to the Kh register 1020, similar to the operation described with respect to FIGS. 7 and 8. The power-up default value of the Kh register 1020 is Kh_otp 1030.

FIGS. 12-13 show the operation at the system integrator. FIG. 12 shows the operation of writing KhB1 to the Kh register. Like FIGS. 10 and 11, FIG. 12 shows a keyed HMAC 1110, Kh register 1120, input register 1114. The input register 1114 contains a query 1 and a system serial number. As shown, the output of HMAC 1110 (KhB1) is written to the Kh register 1120, similar to the operation described with respect to FIGS. 7, 8, and 11. The output of the HMAC 1110 is a secret known to the system integrator, but not to the fab.

FIG. 13 shows the operation of reading KhA2. As before, FIG. 13 shows an HMAC 1210, output register 1212, input register 1214, and Kh register 1220. In this example, the HMAC 1210 is keyed with KhA1, resulting in an output of KhA2, which is the secret belonging to the system integrator.

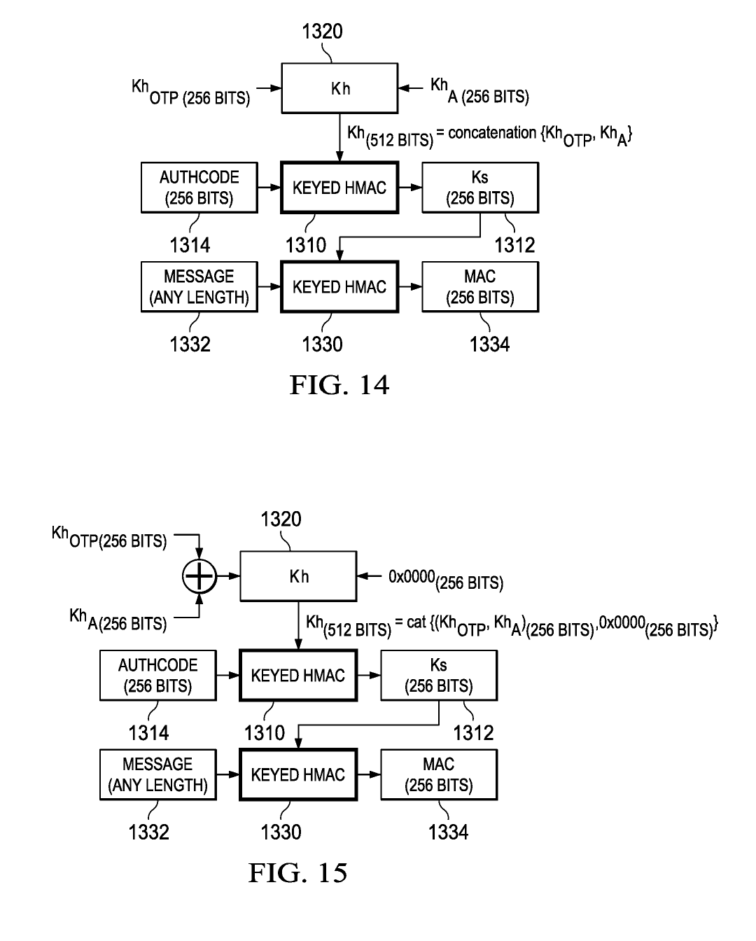

FIGS. 14-16 are block diagrams showing additional examples of distributed device activation mechanisms. FIG. 14 shows a keyed HMAC 1310 that calculates a device secret (Ks) 1312 based on an Authcode input 1314 and a key input (Kh) 1320. In this example, the key input Kh 1320 is derived from the hardware secret Kh_otp and KhA. In some embodiments, the Authcode is received from a service. The device secret (Ks) 1312 is used by keyed HMAC 1330 to encrypt and/or decrypt message 1332, resulting in MAC 1334.

FIG. 15 is a block diagram similar to FIG. 14, but with the key input (Kh) 1320 generated in a different manner. In this example, the key (Kh) is derived from an exclusive OR (XOR) of the hardware secret Kh_otp and KhA, and a string (in the example of FIG. 13, shown as 0).

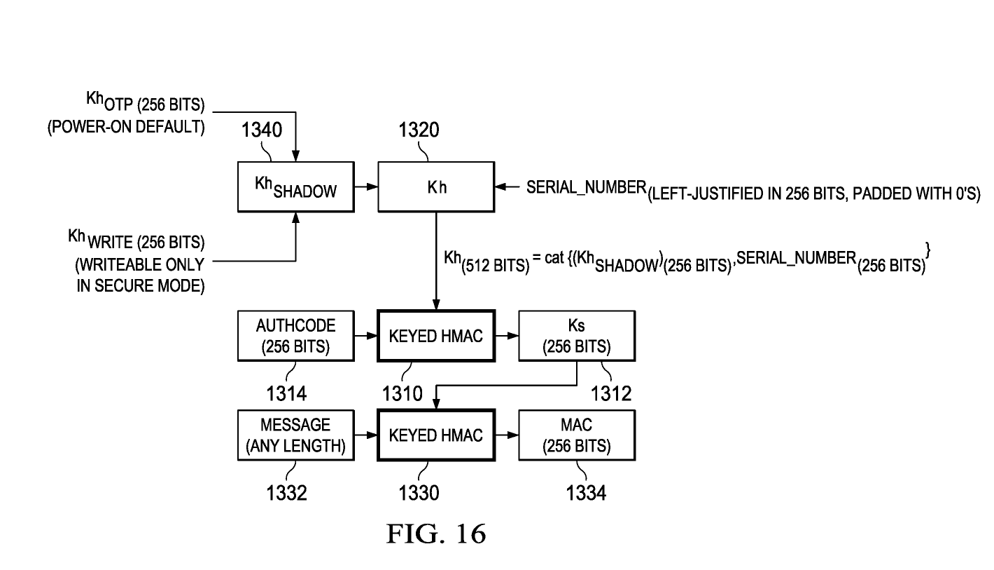

FIG. 16 is a block diagram similar to FIGS. 14 and 15, but with the key input (Kh) generated in a different manner. In this example, the key (Kh) 1320 is derived from a serial number and the values of a Kh_SHADOW register 1340. The value of register 1340 is based on the hardware secret Kh_otp (the power-on default) and/or Kh_WRITE, which is only writable in secure mode.

Although the invention has been described with respect to specific embodiments thereof, these embodiments are merely illustrative, and not restrictive of the invention. The description herein of illustrated embodiments of the invention, including the description in the Summary, is not intended to be exhaustive or to limit the invention to the precise forms disclosed herein (and in particular, the inclusion of any particular embodiment, feature or function within the Summary is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function, including any such embodiment feature or function described in the Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylus, touch pad, etc.), or the like.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any, hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term (i.e., that the reference “a” or “an” clearly indicates only the singular or only the plural). Also, as used in the description herein and throughout the claims that follow, the meaning of “in” includes “in” and “on” unless the context clearly dictates otherwise.

What is claimed is:

1. A method for performing remote authentication and activation of a device involving a group of external entities without using asymmetric cryptography comprising:
providing a hardware secret;
providing unique input data, the unique input data including authenticated data from one or more of the external entities;
using a hardware hash function to derive a shared secret from the hardware secret and the unique input data, wherein the shared secret is unknown to each of the external entities; and
writing the derived shared secret to a security register of the device.

2. The method of claim 1, further comprising encrypting the derived shared secret and communicating the encrypted derived shared secret to an external entity.

3. The method of claim 1, wherein using the hardware hash function to derive the shared secret from the hardware secret and the unique input data further comprises:
providing the hardware secret as a key to the hardware hash function; and
providing the unique input data as input data to the hardware hash function, wherein the output of the hardware hash function is the shared secret.

4. The method of claim 3, further comprising deriving a second shared secret, wherein deriving the second shared secret comprises:
providing the derived shared secret as a key to the hardware hash function; and
providing additional unique input data as input data to the hardware hash function, wherein the output of the hardware hash function is the second shared secret.

5. The method of claim 4, further comprising deriving a third shared secret, wherein deriving the third shared secret comprises:
providing the second shared secret as a key to the hardware hash function; and
providing second additional unique input data as input data to the hardware hash function, wherein the output of the hardware hash function is the third shared secret.

6. The method of claim 1, wherein the shared secret is usable by each of the external entities.

7. The method of claim 1, wherein the shared secret is re-creatable only by providing the authenticated data from each of the external entities.

8. The method of claim 1, wherein the authenticated data from each of the external entities is unknown by the other external entities.

9. A system for authenticating and activating a device involving a group of external entities without using asymmetric cryptography comprising:
a processor;
a secure execution controller;
a hardware hash function; and
at least one non-transitory computer-readable storage medium storing computer instructions translatable by the processor to perform:
providing unique input data as an input to the hardware hash function, the unique input data including authenticated data from one or more of the external entities;
providing a hardware secret as a key to the hardware hash function to derive a shared secret based on the hardware secret and the unique input data; and
storing the output of the hardware hash function in a security register of the device.

10. The system of claim 9, further comprising encrypting the derived shared secret and communicating the encrypted derived shared secret to an external entity.

11. The system of claim 9, wherein the computer instructions translatable by the processor further performs:
providing additional unique input data as an input to the hardware hash function, the additional unique input data including authenticated data from one or more of the external entities;
providing the derived shared secret as a key to the hardware hash function to derive a second shared secret based on the derived secret and the additional unique input data; and
storing the second shared secret in the security register of the device.

12. The system of claim 11, wherein the computer instructions translatable by the processor further performs:
providing second additional unique input data as an input to the hardware hash function, the second additional unique input data including authenticated data from one or more of the external entities;
providing the second derived shared secret as a key to the hardware hash function to derive a third shared secret based on the second derived secret and the second additional unique input data; and
storing the third shared secret in the security register of the device.

13. The system of claim 9, wherein the shared secret is usable by each of the external entities.

14. The system of claim 9, wherein the shared secret is re-creatable only by providing the authenticated data from each of the external entities.

15. The system of claim 9, wherein the authenticated data from each of the external entities is unknown by the other external entities.

16. A computer program product comprising at least one non-transitory computer-readable storage medium storing computer instructions translatable by one or more processors to perform:
providing a hardware secret of a device as a key to a hardware hash function;
providing unique input data as an input to the hardware hash function, the unique input data including authenticated data from one or more external entities;
instructing the hardware hash function to derive a shared secret from the hardware secret and the unique input data, wherein the shared secret is unknown to each of the external entities, wherein the shared secret is derived without using asymmetric cryptography; and
writing the derived shared secret to a security register of the device.

17. The computer program product of claim 16, further comprising encrypting the derived shared secret and communicating the encrypted derived shared secret to an external entity.

18. The computer program product of claim 16, further comprising instructing the hardware hash function to derive a second shared secret, wherein deriving the second shared secret comprises:
providing the derived shared secret as a key to the hardware hash function; and
providing additional unique input data as input data to the hardware hash function, wherein the output of the hardware hash function is the second shared secret.

19. The computer program product of claim 18, further comprising instructing the hardware hash function to derive a third shared secret, wherein deriving the third shared secret comprises:
providing the second derived shared secret as a key to the hardware hash function; and
providing second additional unique input data as input data to the hardware hash function, wherein the output of the hardware hash function is the third shared secret.

20. The computer program product of claim 16, wherein the authenticated data from each of the external entities is unknown by the other external entities.
